(19) United States
(12) Patent Application Publication
(10) Pub. No.: US 2014/0170303 A1
(43) Pub. Date: Jun. 19, 2014

(54) ELECTRODEPOSITION PROCESS FOR THE MANUFACTURE OF AN ELECTRODE FOR A METIAL-ION BATTERY

(71) Applicants: Phil Rayner, Cambridgeshire (GB); Mike Lain, Oxfordshire (GB); Jeremy Barker, Oxfordshire (GB)

(72) Inventors: Phil Rayner, Cambridgeshire (GB); Mike Lain, Oxfordshire (GB); Jeremy Barker, Oxfordshire (GB)

(73) Assignee: NEXEON LIMITED, Oxfordshire, GB (UK)

(21) Appl. No.: 14/236,309

(22) PCT Filed: Aug. 17, 2012
(86) PCT No.: PCT/GB12/52020

§ 371 Date: Jan. 30, 2014

(30) Foreign Application Priority Data
Aug. 18, 2011 (GB) 1114266.8

(51) Int. Cl. C25D 1/00; H01M 4/04; H01M 4/1395; H01M 4/38; H01M 4/46

(52) U.S. Cl. CPC C25D 1/00; H01M 4/387; H01M 4/463; H01M 4/386; H01M 4/1395; H01M 4/0404
USPC 427/58; 205/57; 216/75; 216/11; 216/77; 216/79

(57) ABSTRACT

A method of depositing an active material for a metal ion battery comprising the steps of: providing a conductive material in an electrodeposition bath wherein the electrodeposition bath contains an electrolyte comprising a source of the active material; and electrodepositing the active material onto a surface of the conductive material.

### FIELD OF THE INVENTION

The present invention relates to a method for forming an active material suitable for a metal ion battery, and for forming an electrode containing the active material such as an anode of a metal ion battery.

### BACKGROUND OF THE INVENTION

Rechargeable lithium-ion batteries are extensively used in portable electronic devices such as mobile telephones and laptops, and are finding increasing application in electric or hybrid electric vehicles.

The structure of a conventional lithium-ion rechargeable cell is shown in FIG. 1. A battery includes at least one cell but may also include more than one cell. Batteries of other metal ions are also known, for example sodium ion and magnesium ion batteries, and have essentially the same cell structure.

The battery cell comprises a current collector for the anode 10, for example copper, and a current collector for the cathode 12, for example aluminium, which are both externally connectable to a load or to a recharging source as appropriate. A composite anode layer 14 overlays the current collector 10 and a lithium containing metal oxide-based composite cathode layer 16 overlays the current collector 12 (for the avoidance of any doubt, the terms “anode” and “cathode” as used herein are used in the sense that the battery is placed across a load—in this sense the negative electrode is referred to as the anode and the positive electrode is referred to as the cathode).

The cathode comprises a material capable of releasing and reinserting lithium ions for example a lithium-based metal oxide or phosphate, LiCoO₂, LiNi_{0.8}Co_{0.15}Al_{0.05}O₂, LiMnₓNiₓCo₁₋₂ₓO₂ or LiFePO₄

A porous plastic spacer or separator 20 is provided between the graphite-based composite anode layer 14 and the lithium containing metal oxide-based composite cathode layer 16. A liquid electrolyte material is dispersed within the porous plastic spacer or separator 20, the composite anode layer 14 and the composite cathode layer 16. In some cases, the porous plastic spacer or separator 20 may be replaced by a polymer electrolyte material and in such cases the polymer electrolyte material is present within both the composite anode layer 14 and the composite cathode layer 16. The polymer electrolyte material can be a solid polymer electrolyte or a gel-type polymer electrolyte and can incorporate a separator.

When the battery cell is fully charged, lithium has been transported from the lithium containing metal oxide cathode layer 16 via the electrolyte into the anode layer 14. In the case of a graphite-based anode layer, the lithium reacts with the graphite to create the compound LiₓC₆ (0<=x<=1). The graphite, being the electrochemically active material in the composite anode layer, has a maximum capacity of 372 mAh/g. (“active material” as used herein means a material which is able to incorporate into its structure and substantially release there from, metal ions such as lithium, sodium, potassium, calcium or magnesium during the charging phase and discharging phase of a battery. Preferably the material is able to incorporate, or insert, and release lithium.)

The use of a silicon-based active anode material, which may have a higher capacity than graphite, is also known.

WO2009/010758 discloses the etching of silicon powder in order to make silicon material for use in lithium ion batteries. The resulting etched particles contain pillars on their surface. The pillared particles may be fabricated by etching a particle having an initial size of 10 to 1000 microns.

The pillared particles may be used as the active material of a lithium ion battery. Alternatively, the pillars may be detached from the pillared particles and used as the active material. The starting material used to form pillared particles may be a relatively high purity single crystal wafer, or a cheaper source of silicon such as metallurgical grade silicon.

US 2010/0285358 discloses silicon nanowires grown on a substrate for use in a lithium ion battery.

US 2010/0297502 discloses silicon nanowires grown on carbon particles for use in a lithium ion battery.

Chen et al, Adv. Funct. Mater. 2011, 21, 380-387, discloses formation of a patterned 3D silicon anode fabricated by electrodeposition of silicon on a virus-structured nickel current collector.

Mallet et al, Nanoletters 2008, 8(1), 3468-3474 discloses the fabrication of silicon nanowires by electrodeposition of silicon into a nanoporous polycarbonate membrane with pores of different diameters. The membrane is provided on a layer of gold. Following electrodeposition into the pores to form nanowires, the layer of gold and the membrane are dissolved to release the nanowires.

Yang et al, Journal of Power Sources 2011, 196, 2868-3873 discloses electrodeposition of a porous microspheres Li—Si film.

US20100297502 discloses attaching or depositing silicon nanostructures onto carbon based substrates including graphite or graphene particles and sheets using the VLS (vapour-liquid-solid) method.

U.S. Pat. No. 7,713,849 discloses a method of making an array of nanowires by electrodeposition into a porous anodised matrix

US20060216603 discloses a cathode for a lithium ion battery comprising electrodeposited lithium oxide nanowires.

JP 03714665 discloses a method of manufacturing an anode by forming a carbon material on a current collector and then electrodepositing a coating of silicon over the active layer.

JP2006172860 discloses a method of making an anode for a lithium ion battery including forming an active layer without binder onto a current collector and then adding a second active layer containing binder.

KR2008091883 discloses electrodeposition of tin or silicon nanoparticles onto carbon nanotubes or carbon fibres to make the active material for an anode.

### SUMMARY OF THE INVENTION

In a first aspect the invention provides a method of forming a plurality of particles comprising an active material suitable for use in a metal ion battery, the method comprising the steps of:

providing a working electrode in an electrodeposition bath wherein the electrodeposition bath contains an electrolyte comprising a source of the active material;

electrodepositing the active material onto a surface of the working electrode, onto a surface of a conducting layer in electrical contact with the working electrode, or onto a surface of conductive particles in the electrolyte; and

providing the particles comprising the active material, wherein the step of providing the particles comprises separation of the electrodeposited material from the working electrode or separation of the conductive particles carrying the electrodeposited active material from the working electrode.

Optionally, the active material is electrodeposited into pores of a porous template over the working electrode.

Optionally, the template is in contact with the working electrode or wherein a template release layer is provided between the working electrode and the template.

Optionally, the active material is electrodeposited onto a surface of the template or a surface of the template release layer.

Optionally, the working electrode is a rotating cylinder electrode.

Optionally, the working electrode extends between and is movable between a substrate source and a substrate receiver, and a path between the substrate source and the substrate receiver passes through the electrodeposition bath.

Optionally, the substrate source is a substrate-supplying reel and the substrate receiver is a substrate-receiving reel.

Optionally, the working electrode is drawn through the electrodeposition bath and different parts of the working electrode surface undergo electrodeposition at different times.

Optionally, the substrate-supplying reel or substrate-receiving reel is a rotating cylinder electrode in electrical contact with the working electrode.

Optionally, the surface of the working electrode is patterned to define recesses on the surface for formation of patterned active material by electrodeposition.

Optionally, the electroactive material is formed on a surface of the working electrode and is separated from the working electrode by selective etching or dissolving of the working electrode.

Optionally, the working electrode is treated to increase its brittleness prior to separation of the working electrode from the active material.

Optionally, the step of providing the particles comprises treating the electrodeposited active material deposited onto the working electrode to form the particles.

Optionally, the electrodeposited material is separated from the working electrode and wherein the separated electroactive material is treated to form the particles having a mean average size smaller than the size of the removed material prior to said treatment.

Optionally, the method comprises the step of etching the surface of the particles.

Optionally, the particles are etched to form pillared particles comprising a particle core and pillars extending from the particle core.

Optionally, the active material is electrodeposited onto the surface of conductive particles in the electrolyte and wherein the deposited active material at least partially coats the conductive particles.

Optionally, the plurality of conductive particles form a packed bed during the electrodeposition.

Optionally, the plurality of conductive particles form a fluidised bed during the electrodeposition.

Optionally, the method comprises the step of removing at least part of the coating of the active material by etching.

Optionally, the coating of the active material is etched to form pillars on the surface of the particles.

Where particles are etched, the electrodeposited active material is optionally silicon and the etchant is hydrogen fluoride, the method comprising the further step of generating silica from H₂SiF₆ formed in the etching process.

Optionally, the active material is selected from silicon, tin and aluminium.

Optionally, the active material is silicon and the source of the active material is a silicon tetrahalide.

Optionally, elemental halogen is generated from the silicon tetrahalide during electrodeposition and wherein the elemental halogen is reacted with a silicon oxide to generate further silicon tetrahalide.

Optionally, the particles comprising the active material are particles active material have at least one dimension in the range of 0.5 nm-1 micron.

Optionally, the method comprises the step of mixing the particles comprising the active material with a solvent to form a slurry.

Optionally, the method comprises the step of mixing the particles comprising the active material with at least one other material.

Optionally, the at least one other material is an active material and/or a conductive material.

Optionally, a gas is bubbled through the electrolyte during the electrodeposition.

Optionally, the electrodeposited active material is amorphous and wherein the amorphous active material is rendered at least partially crystalline by a heat treatment.

Optionally, a passivating film is formed on the electrodeposited active material.

In a second aspect, the invention provides a method of forming an electrode layer, the method comprising the step of depositing the particles comprising the active material according to the first aspect onto a conductive material.

Optionally according to the second aspect, the particles comprising the active material are thermally bonded to the conductive material.

Optionally according to the second aspect, the method comprises the step of depositing the slurry as described in the first aspect onto the conductive material and evaporating the solvent.

Optionally according to the second aspect, the electrode layer is an anode layer of a metal ion battery.

In a third aspect the invention provides a method of forming a metal ion battery comprising formation of a structure comprising an electrolyte between the anode according of the second aspect and a cathode capable of releasing and absorbing the metal ion.

In a fourth aspect the invention provides a method of forming particles comprising an active material suitable for a metal ion battery, the method comprising the steps of:

providing a working electrode in an electrodeposition bath wherein the electrodeposition bath contains an electrolyte comprising a source of the active material; and

electrodepositing the active material onto a surface of the working electrode; and

separating the electrodeposited active material from the working electrode; and

treating the active material separated from the working electrode to form particles having a mean average size smaller than the size of the removed material prior to said treatment.

In a fifth aspect the invention provides a method of forming particles comprising an active material suitable for a metal ion battery, the method comprising the steps of:

providing a working electrode in an electrodeposition bath wherein the electrodeposition bath contains an electrolyte comprising a source of the active material; and

electrodepositing the active material into pores of a porous template in contact with the working electrode.

In a fifth aspect the invention provides a method of forming particles comprising an active material suitable for a metal ion battery, the method comprising the steps of:

providing conductive particles in an electrolyte of an electrodeposition bath wherein the electrolyte comprises a source of the active material; and

electrodepositing the active material onto the conductive particles to at least partially coat the conductive particles.

The methods of any of the third, fourth and fifth aspects may include any of the optional features described in the method of the first aspect including, without limitation, steps of etching particles as described in the first aspect, structure of the electrodeposition apparatus and method of electrodeposition.

In a sixth aspect the invention provides a method of forming an electrode layer, the method comprising the step of depositing the particles comprising the active material according to any of the third, fourth and fifth aspects onto a conductive material.

Optionally according to the sixth aspect, the particles comprising the active material are thermally bonded to the conductive material.

Optionally according to the sixth aspect, the method comprises the step of depositing a slurry comprising the particles comprising the active material and a solvent onto the conductive material and evaporating the solvent.

Optionally according to the sixth aspect, the electrode layer is an anode layer of a metal ion battery.

In a seventh aspect the invention provides a method of forming a metal ion battery comprising formation of a structure comprising an electrolyte between the anode according to the sixth aspect and a cathode capable of releasing and absorbing the metal ion.

A powder may be obtained by separating the plurality of particles containing electrodeposited active material. This powder may be used to form an electrode or active component of an electrical, electronic or optical device, for example a metal ion battery, as described anywhere herein.

In an eighth aspect the invention provides a method of depositing an active material for a metal ion battery comprising the steps of:
providing a conductive material in an electrodeposition bath wherein the electrodeposition bath contains an electrolyte comprising a source of the active material; and
electrodepositing the active material onto a surface of the conductive material.

Optionally according to the eighth aspect, the conductive material is a working electrode onto which the active material is deposited.

Optionally according to the eighth aspect, the active material is electrodeposited into pores of a porous template in contact with the conductive material.

Optionally according to the eighth aspect, the working electrode is a rotating cylinder electrode.

Optionally according to the eighth aspect, the conductive material extends between and is movable between a substrate source and a substrate receiver, and a path between the substrate source and the substrate receiver passes through the electrodeposition bath.

Optionally according to the eighth aspect, the substrate source is a substrate-supplying reel and the substrate receiver is a substrate-receiving reel.

Optionally according to the eighth aspect, the conductive material is drawn through the electrodeposition bath and different parts of the conductive material surface undergo electrodeposition at different times.

Optionally according to the eighth aspect, the substrate-supplying reel or substrate-receiving reel is a rotating cylinder electrode in electrical contact with the conductive material.

Optionally according to the eighth aspect, the surface of the conductive material is patterned to define recesses on the surface for formation of patterned active material by electrodeposition.

Optionally according to the eighth aspect, the electrodeposited active material is separated from the conductive material.

Optionally according to the eighth aspect, the conductive material is separated from the electrodeposited active material by selective etching or dissolving of the conductive material.

Optionally according to the eighth aspect, the conductive material is treated to increase brittleness of the conductive material prior to separation of the conductive material from the active material.

Optionally according to the eighth aspect, the method comprises the further step of treating the electrodeposited active material separated from the conductive material to form particles having a mean average size smaller than the size of the removed material prior to said treatment.

Optionally according to the eighth aspect, the method comprises the step of etching the surface of the particles.

Optionally according to the eighth aspect, the particles are etched to form pillared particles comprising a particle core and pillars extending from the particle core.

Optionally according to the eighth aspect, the conductive material comprises a plurality of conductive particles and the deposited active material at least partially coats the conductive particles.

Optionally according to the eighth aspect, the plurality of conductive particles form a fluidised bed during the electrodeposition.

Optionally according to the eighth aspect, the method comprises the step of removing at least part of the coating of the active material by etching.

Optionally according to the eighth aspect, the coating of the active material is etched to form pillars on the surface of the particles.

Optionally according to the eighth aspect, the electrodeposited active material is silicon and the etchant is hydrogen fluoride, the method comprising the further step of generating silica from H₂SiF₆ formed in the etching process.

Optionally according to the eighth aspect, the active material is selected from silicon, tin and aluminium.

Optionally according to the eighth aspect, the source of the active material is a silicon tetrahalide.

Optionally according to the eighth aspect, elemental halogen is generated from the silicon tetrahalide during electrodeposition and wherein the elemental halogen is reacted with a silicon oxide to generate further silicon tetrahalide.

Optionally according to the eighth aspect, particles of the active material or the conductive particles at least partially coated with the active material have at least one dimension in the range of 0.5 nm-1 micron.

Optionally according to the eighth aspect, the method comprises the step of mixing the particles of the active material or the conductive particles at least partially coated with the active material with a solvent to form a slurry.

Optionally according to the eighth aspect, the method comprises the step of mixing the particles of the active material or the conductive particles at least partially coated with the active material with at least one other material.

Optionally according to the eighth aspect, the at least one other material is an active material and/or a conductive material.

Optionally according to the eighth aspect, a gas is bubbled through the electrolyte during the electrodeposition.

Optionally according to the eighth aspect, the electrodeposited active material is amorphous and wherein the amorphous active material is rendered at least partially crystalline by a heat treatment.

Optionally according to the eighth aspect, a passivating film is formed on the electrodeposited active material.

In a ninth aspect the invention provides a method of forming an anode layer of a metal ion battery comprising the step of depositing the slurry onto a conductive material and evaporating the solvent.

In a tenth aspect, the invention provides a method of forming a metal ion battery comprising formation of a structure comprising an electrolyte between the anode the second aspect and a cathode capable of releasing and absorbing the metal ion.

In an eleventh aspect, the invention provides a method of forming a metal ion battery comprising an anode current collector, an anode layer, a cathode layer capable of releasing and reinserting the metal ion and an electrolyte between the anode layer and the cathode layer, wherein the anode current collector and anode layer are formed from the working electrode carrying electrodeposited active material.

In a twelfth aspect, the invention provides a method of recycling elemental halogen comprising the steps of:
generating elemental halogen by electrolytic reduction of a silicon halide during electrodeposition of silicon; and
reacting the generated elemental halogen with a silicon oxide to generate further silicon halide.

Optionally according to the twelfth aspect, the silicon halide is a silicon trihalide or tetrahalide, and the halide is optionally a bromide or chloride.

It will be appreciated that particles comprising the active material as described anywhere herein includes particles of the active material and conductive particles at least partially coated with the active material.

### DESCRIPTION OF THE DRAWINGS

The invention will now be described in more detail with reference to the drawings wherein:

FIG. 1 is a schematic illustration of a lithium ion battery;

FIG. 2 is a schematic illustration of apparatus for an electrodeposition process according to an embodiment of the invention;

FIG. 3 is a flow chart illustrated a process according to an embodiment of the invention;

FIG. 4 is a schematic illustration of a process for forming an anode of a metal ion battery from an electrodeposited film according to an embodiment of the invention;

FIG. 5A is a schematic illustration of apparatus for an electrodeposition process according to another embodiment of the invention;

FIG. 5B is a schematic illustration of apparatus for an electrodeposition process according to another embodiment of the invention;

FIG. 6A illustrates a cross-section of an electrodeposited film formed on a patterned substrate according to an embodiment of the invention;

FIG. 6B illustrates a plan view of the electrodeposited film and substrate of FIG. 6A;

FIG. 7A illustrates a plan view of a template for use in a process according to an embodiment of the invention;

FIG. 7B illustrates schematically an electrodeposition process according to an embodiment of the invention using the template of FIG. 7A;

FIG. 7C illustrates schematically an electrodeposition process according to an embodiment of the invention using a further template;

FIG. 8 is a schematic illustration of apparatus for an electrodeposition process according to an embodiment of the invention; and

FIG. 9 is a schematic illustration of a process for forming a pillared particle from a particle with an electrodeposited coating.

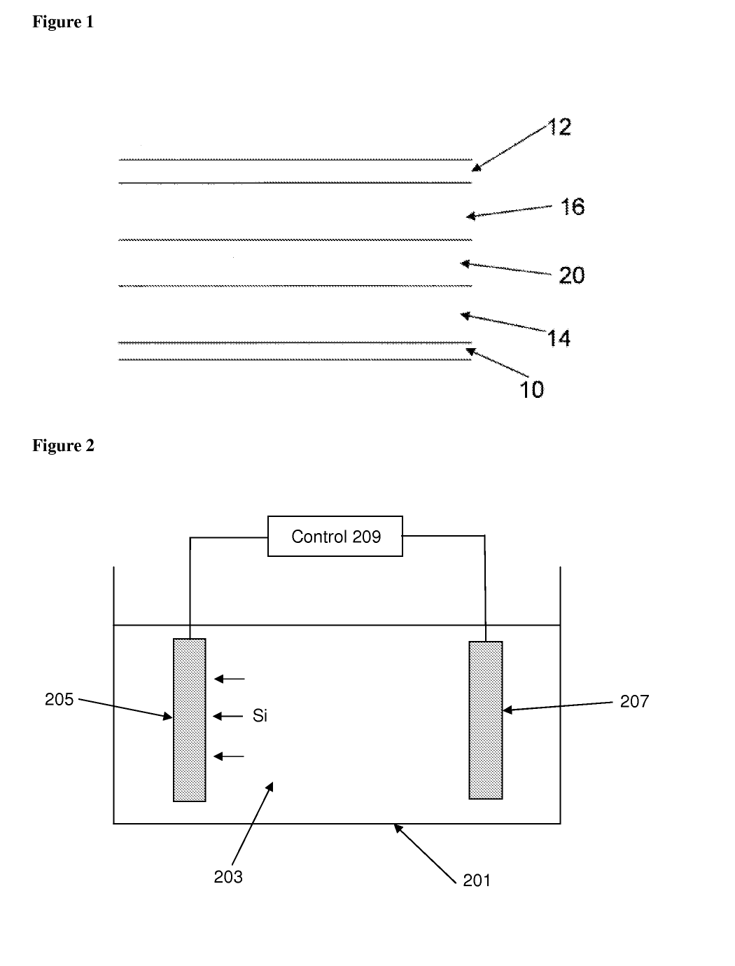

### DETAILED DESCRIPTION OF THE INVENTION

The invention is described herein with reference to lithium ion batteries and absorption and desorption of lithium ions, and with reference to electrodeposition of silicon, however it will be appreciated that the invention may be applicable to other metal ion batteries, for example sodium or magnesium ion batteries, and to deposition of materials other than silicon, for example tin; oxides of tin or silicon; silicon alloys or other mixtures comprising silicon; and tin alloys or other mixtures comprising tin. Moreover, it will be appreciated that electrodeposited materials as described herein may be used in devices other than metal ion batteries, for example filters, other energy storage devices such as fuel cells, photovoltaic devices such as solar cells, sensors, capacitors. Electrodeposited materials as described herein may also form conducting or semiconducting components of electronic circuitry.

With reference to FIG. 2, apparatus for electrodeposition of silicon comprises a bath 201 for containment of an electrolyte 203; a working electrode 205 that provides a substrate onto which silicon may be deposited and a counter electrode 207. The working electrode 205 and counter electrode 207 are connected to a control 209. The control 209 may provide current, such as continuous direct current, pulsed direct current or alternating current, such that silicon is deposited at a required rate. A reference electrode (not shown) may also be provided. The cell may also contain a porous separator between the two electrodes (not shown). The electrolyte may be a non-aqueous electrolyte, for example a polar, aprotic organic solvent such as propylene carbonate, ethylene carbonate, acetonitrile, tetrahydrofuran, dimethylcarbonate and diethylcarbonate. Alternatively, the electrolyte may be an ionic liquid electrolyte such as a room temperature ionic liquid.

A source of silicon is dissolved in the electrolyte. Suitable silicon sources include compounds of formula SiX₄ or SiHX₃ wherein X in each occurrence is independently selected from Cl or Br. The electrolyte may also contain a salt to increase the ionic conductivity e.g. tetraethyl ammonium borofluorate.

The following half-reactions take place during electrodeposition, illustrated here by the case where the silicon source is silicon tetrachloride:

SiCl₄+4e⁻→Si+4Cl⁻ (working electrode)

4Cl⁻→2Cl₂+4e⁻ (counter electrode)

Silicon tetrachloride may be formed by the following reaction of silica, carbon and chlorine in the presence of a catalyst e.g. such as BCl₃ or POCl₃, at a temperature of about 700° C.:

SiO₂+2C+2Cl₂→SiCl₄+2CO

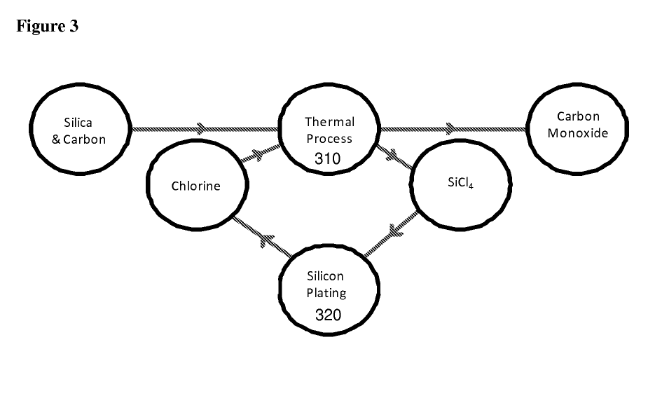

Chlorine formed during the electrodeposition process described above may be recycled to form SiCl₄, as illustrated in FIG. 3.

At step 310, silica and carbon are reacted at an elevated temperature to produce carbon monoxide and SiCl₄. The SiCl₄ is used in the electrodeposition process 320 to produce chlorine, which is recycled to the reaction for forming SiCl₄.

It will be appreciated that there will be little or no correlation between the purity of the starting material used to form the silicon source and the purity of the electrodeposited silicon film, and so the material used to form the silicon source may be of a relatively low purity (for example less than 98% or less than 95%). For example, silicon tetrachloride may be formed from low purity silica without adversely affecting the purity of the silicon film formed by electrodeposition. However, the silica must not contain impurities at a concentration that would poison the catalyst, or inhibit the reactions in some other way.

The rate at which silicon is deposited may be at least 1 micron/hour, optionally at least 10 microns/hour. Rates above 10 microns/hour may be preferred. The potential difference between the working and counter electrodes may be selected according to the desired silicon deposition rate. A high deposition rate may provide a less dense film, with more space for expansion of silicon during absorption of lithium, as compared to slower deposition rates.

A gas, for example hydrogen, may be bubbled through the electrolytic bath to cause foaming in the electrodeposited film. Voids formed in the foamed electrodeposited film may provide expansion space during absorption of lithium.

Electrodeposited silicon may be amorphous and may be used as an active material in this form or may be made fully or partially crystalline by various known techniques such as solid-phase crystallization (which requires the silicon to be heated to temperatures higher than 250° C.), laser crystallization (in which regions of the silicon material are locally heated by a laser above the melting point) or metal-induced crystallization (where the silicon is annealed at low temperatures such as 150° C. in contact with a metal film such as silver, gold or aluminium).

The electrodeposited film may contain Si—H bonds that are prone to oxidation and formation of non-active silicon dioxide (silica) on the surface is preferably avoided. The electrodeposited material may be maintained in a substantially oxygen-free environment until such a time as it is sealed from the environment during the process of battery manufacture. Alternatively, the electrodeposited material may be subjected to a stabilising (or passivating) treatment to form a thin (a few nm, for example 1-10 nm) film on the surface of the silicon that prevents oxidation. Such passivating films include alumina, oxides, hydrides, nitrides and fluorides. Preferably the passivating film does not impede the insertion of the metal ions into the silicon. An exemplary stabilising treatment is heat treatment, for example at a temperature in the range of about 250° C. and 350° C. in a substantially oxygen free atmosphere, for example heat treatment in a hydrogen, nitrogen and/or noble gas environment. Stabilisation of an amorphous film by heat treatment is described in, for example, U.S. Pat. No. 4,192,720. Examples of preferred passivating films include metal fluorides, for example lithium fluoride, metal carbonates, for example lithium carbonate, silicon nitride and titanium dioxide. Passivation may comprise exposure of the film to a reactive gas, for example elemental hydrogen, oxygen, fluorine or nitrogen, for reaction of dangling bonds at the film surface. The passivation layer may also function as a solid-electrolyte interphase.

The electrodeposited film may consist essentially of the electrodeposited material. Alternatively, other materials may be incorporated into the film during the electrodeposition process by providing them as particulate additives in the electrolyte. For example, carbon may be incorporated into the film by providing particulate carbon in the electrolyte. The electrolyte may be agitated, for example stirred, during the electrodeposition process to prevent the particulate additive from settling on the working electrode. Incorporation of particulate fluoride, such as lithium fluoride, may provide a anode material with a “built-in” solid-electrolyte interphase and serve to passivate the electrodeposited film.

The silicon may also be doped to produce p-type or n-type doped silicon to improve its conductivity. Dopants may for example include Al, B, P. Doping may be performed in-situ during formation of the electro-deposited silicon by adding a suitable dopant to the electrolyte. Metal-ions of the cell, e.g. lithium, may also be incorporated into or on the surface of the silicon during the electrodeposition or in post electrodeposition treatments.

The working electrode substrate may be used directly to form a lithium ion battery, without removal of the electrodeposited silicon, in which case the substrate becomes the anode current collector and the electrodeposited silicon layer becomes the anode layer of the lithium ion battery. In a preferred arrangement, the electrodeposited silicon is separated from the substrate and is applied to another conductive layer, for example using a slurry containing the electrodeposited silicon or thermal bonding of the electrodeposited silicon, to form the anode current collector and the anode layer of a lithium ion battery.

Use of separate conductive layers as the working electrode for electrodeposition and as the anode current collector layer allows for optimisation of the working electrode and the anode current collector. Optimisations include choice of conductive material and thickness of conductive material. An optimal thickness of the working electrode required to withstand mechanical requirements of the electrodeposition process may be greater than a thickness of the anode current collector for optical energy density of the lithium ion battery.

Further advantages of use of a separate anode current collector layer may include:
Control of the thickness and porosity of the anode layer that is independent of the electrodeposition process conditions and duration.
Inclusion of components in the anode layer other than the electrodeposited material, for example one or more binders or conductive additives included in a slurry used to form the anode layer (a binder may be particularly beneficial in avoiding delamination of the anode layer).
Ease of cleaning and removal of contaminants such as components of the electrolyte that may remain on the surface of the electrodeposited silicon after the electrodeposition process.

If electrodeposited silicon is separated from the substrate, as described in more detail below, then annealing, crystallization, stabilising, doping or other post electrodeposition treatments may take place before or after the silicon is separated from the substrate.

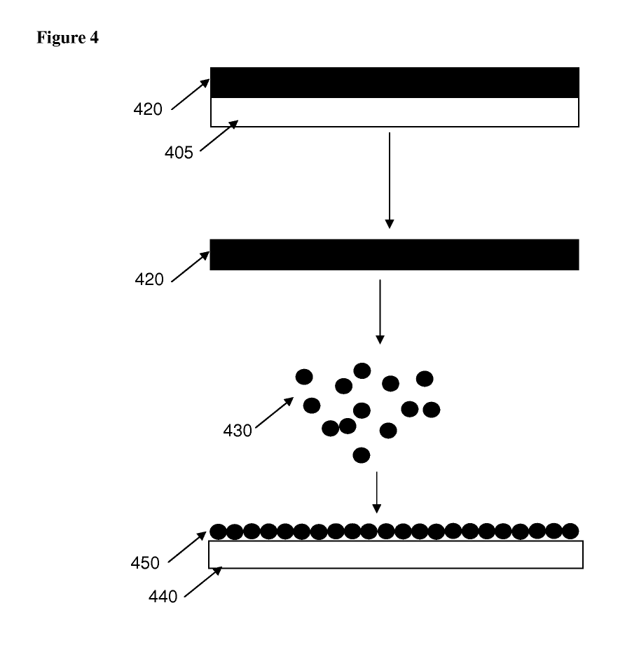

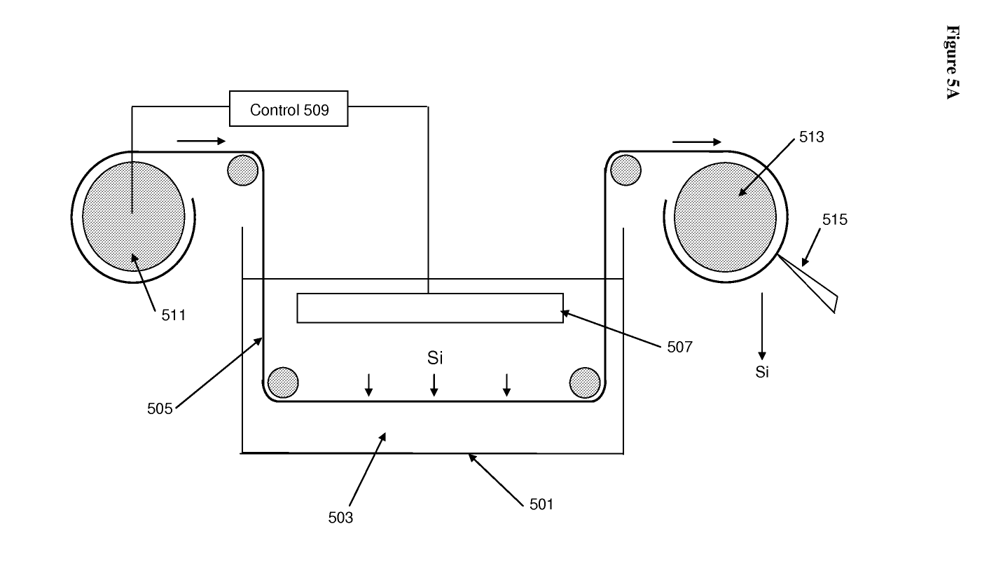

FIG. 4 illustrates formation of an anode of a metal ion battery from the electrodeposited film according to one embodiment.

Following formation of an electrodeposited film 420 on conductive substrate 405, the layer of silicon 420 is separated from the substrate 405. In FIG. 4, the electrodeposited film 420 is shown to be substantially unbroken following separation from substrate 405, however it will be appreciated that the film may be broken during separation of film 420 from substrate 405.

Exemplary methods for separating the electrodeposited film 410 from the conductive substrate include mechanical methods such as scraping the film off the substrate and bending the substrate, and chemical methods such as etching.

The active material used to form an anode may comprise particles having at least one smallest dimension less than one micron. Preferably the smallest dimension is less than 500 nm, more preferably less than 300 nm. The smallest dimension may be more than 0.5 nm. The smallest dimension of a particle is defined as the size of the smallest dimension of an element of the particle such as the diameter for a rod, fibre or wire, the smallest diameter of a cuboid or spheroid or the smallest average thickness for a ribbon, flake or sheet where the particle may consist of the rod, fibre, wire, cuboid, spheroid, ribbon, flake or sheet itself or may comprise the rod, fibre, wire, cuboid, spheroid, ribbon, flake or sheet as a structural element of the particle. For a 3D mesh type structure this smallest dimension might be the thinnest section of the mesh, and this mesh may then be scraped or broken up by mechanical crushing or grinding into spheroidal or other particles.

Preferably the particle has a largest dimension that is no more than 1 mm preferably no more than 500 microns, preferably no more than 100 μm, more preferably, no more than 50 μm and especially no more than 30 μm. The particle preferably has a largest dimension of at least 0.5 microns.

Particle sizes may be measured using optical methods, for example scanning electron microscopy.

In a composition containing a plurality of particles, for example a powder, preferably at least 20%, more preferably at least 50% of the particles have smallest and/or largest dimensions in the ranges defined herein. Particle size distribution may be measured using laser diffraction methods or optical digital imaging methods.

The process by which film 420 is separated from substrate 405 may result in production of particles having the required dimensions. For example, scraping of film 420 may produce particles having the required dimensions.

However, if the removal process results in little or no breakage of film 420, or breakage that does not produce active material of the required size, then a treatment step may be carried out to produce particles 430 having the required size. Exemplary treatments include mechanical treatments, such as grinding or milling, or chemical treatments, such as etching.

The particles 430 may have any shape and may be, for example, flakes, wires, fibres cuboid, substantially spherical or spheroid particles. Flakes formed in this way may have a thickness of up to about 20 microns or 10 microns, 2 microns, optionally about 0.1 microns, and other dimensions in the range of 5-50 microns. A flake may have a thickness of at least about 20 nm. Wires, fibres, rods or ribbons may have smallest dimensions as the diameter or minimum thickness of up to 2 microns, optionally about 0.1 microns and may have lengths of more than 1 m, optionally more than 5 μm with aspect ratios of at least 2:1, optionally at least 5:1 or at least 10:1. The smallest dimensions may be at least about 10 nm. The ribbons may have widths that are at least twice the minimum thickness, optionally at least five times the minimum thickness.

FIG. 420 illustrates a continuous film that covers substantially the whole of one surface of substrate 405. However, the film formed may be non-continuous, and may for example be in the form of a plurality of “islands” of the active material having dimensions within the range required for use in a battery, in which case further treatment to reduce the size of particles scraped or otherwise removed from the substrate may not be necessary. For example, deposition at a high rate, such as at a rate of above 10 microns/hour, may produce a non-continuous film. The methods of creating coatings which are continuous but are then removed from the substrate to form wires, flakes or shells can also be performed to make coatings which are not continuous whereby the layer formed by electrodeposition has been made porous or mesh-like by techniques such as using much higher current density and deposition rates than would form a continuous Si film or adding impurities to the deposition liquid which caused deposition discontinuities. When these coatings are broken up into fragments they allow the minimum dimension to be characteristically smaller e.g. 10-200 nm whereas the coating thickness may be relatively large at 1-1000 um, and the coating is then broken up into porous particles, or even down into open pored fragments.

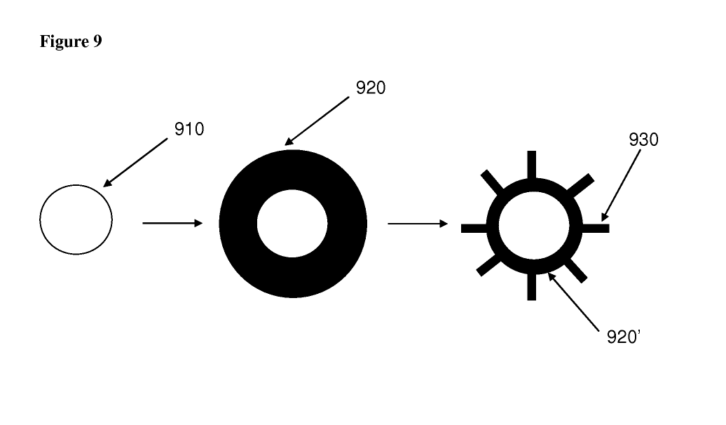

Particles 430 may be etched to form pillared particles. The process of etching particles to form pillared particles is described in detail below with reference to FIG. 9, and it will be appreciated that etching of particles 430 may be performed in the same way.

Formation of wires and meshes of silicon may also be encouraged by pre-patterning the surface of the working electrode before electrodepositing. One method of pre-patterning is the “tobacco virus” method in which a virus binds in patterns to a conductive surface. A random or ordered distribution of islands of metal ions (e.g. silver, copper, tin, nickel) may also be formed from single ions or a cluster of ions, preferably islands of size 30-300 nm in diameter, by using any suitable deposition technique such as, for example, electroless deposition (for example, deposition of silver particles or clusters from a solution of silver nitrate or copper ions from a solution of copper sulfate). The islands act as a self-assembled pattern of dots to encourage silicon wires to grow rather than a continuous layer. The surface of the working electrode may be patterned to form a mesh, resulting in formation of electrodeposited flakes of the active material. Flakes formed in this way may have a thickness of up to about 5 microns, 2 microns, optionally about 0.1 microns, and other dimensions in the range of 5-50 microns. A flake may have a thickness of at least about 20 nm.

The surface of particles 430 formed from film 420 may be etched, for example using techniques such as liquid-phase chemical or electrochemical etching (including metal-assisted etching) or reactive ion etching, or plasma etching to form pillared particles comprising a core with pillars extending from the core. The process of pillared particle formation and the structure of pillared particles is described in more detail below. Alternatively the particles may be etched using liquid phase chemical or electrochemical etching techniques such as stain etching to form porous particles or particles with a solid core and porous outer shell. The porous silicon particles are distinguished from the pillared silicon particles in that the etched silicon region of the porous particle substantially forms an interconnected silicon structure with voids or spaces within it, whilst the etched region of the pillared particle comprise a substantially connected network of voids with individual silicon structures extending into the void space. Amorphous or crystalline silicon may be etched, and it will be understood that certain etching techniques may be more suitable for etching crystalline or polycrystalline silicon rather than amorphous silicon in which case the amorphous silicon particles may be fully or partially crystallized using techniques described herein before etching is performed.

A slurry comprising the particles 430 or particles derived therefrom, for example pillared particles or porous particles, and a solvent or solvent mixture may be formulated, and this slurry may be deposited onto a conductive anode current collector 440 followed by evaporation of the solvent or solvent mixture to form the anode 450 of a lithium-ion battery.

Substantially all of the particles may be discrete particles. By “discrete particles” as used herein is meant particles that are not linked to one another. For example, in the case of pillared particles the pillars of different particles may not be entangled. By avoiding any physical linkage between particles, the phenomenon of “heave” resulting from an expansion of an interconnected mass of active material during lithium absorption may be reduced or eliminated.

As an alternative to formation of particles after electrodeposition, as described and illustrated with reference to FIG. 4, a powder of active particles may be formed by providing particles of a conductive material in the electrolyte of an electrodeposition bath, for example an electrodeposition bath as described in FIG. 2, at least partially coating the conductive particles with the active material, and separating the powder of active particles from the electrodeposition bath.

The particles may be able to move within the electrolyte, or may be substantially immobile. One method of immobilising the particles is by formation of a packed bed of the particles in the electrodeposition bath. The electrodeposition bath may contain a porous membrane or separator to constrain the particles of the packed bed to an area within the bath in which the particles are packed together and in electrical contact with the working electrode. In another arrangement, the particles may be constrained by gravity to a bottom surface of an electrodeposition bath.

The particles within the electrolyte may or may not be in electrical contact with the working electrode. Electrical contact between the working electrode and a conductive particle, for example a conductive particle in a packed bed of particles, may be through direct contact between the working electrode and the conductive particle or through a conducting path of one or more conducting particles between the conductive particle and the working electrode.

If particles are able to move within the electrolyte then individual particles may move in and out of electrical contact with the working electrode during electrodeposition. If particles form a packed bed then essentially all particles may be in electrical contact with the working electrode during electrodeposition.

The surface of the particles may be partially or fully coated by the active material. In the case of a packed bed, electrodeposition may occur only on exposed surfaces of the particles of the bed, and the extent of surface coverage may be greatest for particles at a surface of the bed. If particles are able to move within the electrolyte then particles may be partially or fully coated. Electrodeposition of an active material onto conductive particles may result in formation of a continuous coating of the active material extending across a plurality of the conductive particles. This may result in formation of a coalesced plurality particles with a continuous coating, particularly if a packed bed is used. In this case, some or essentially all of the conductive particles may coalesce into one or more masses of coalesced particles.

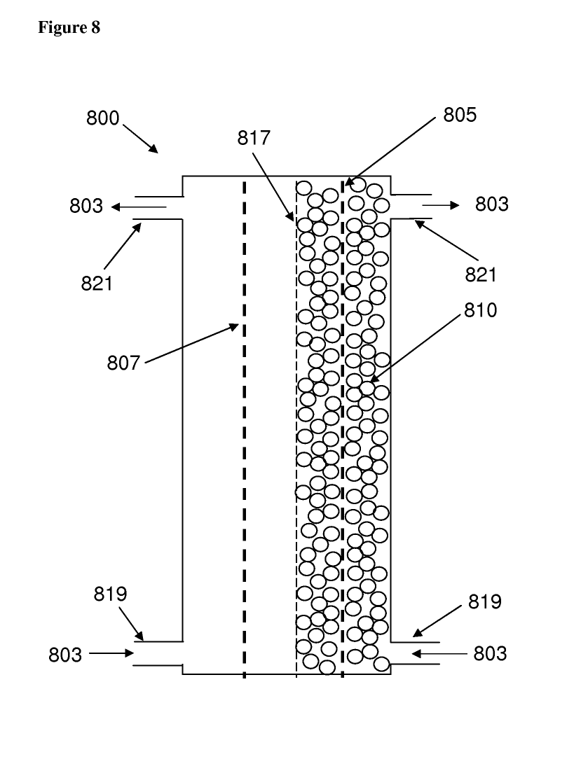

The conductive particles, and the at least partially coated particles formed following electrodeposition, may be as described with reference to FIG. 8.

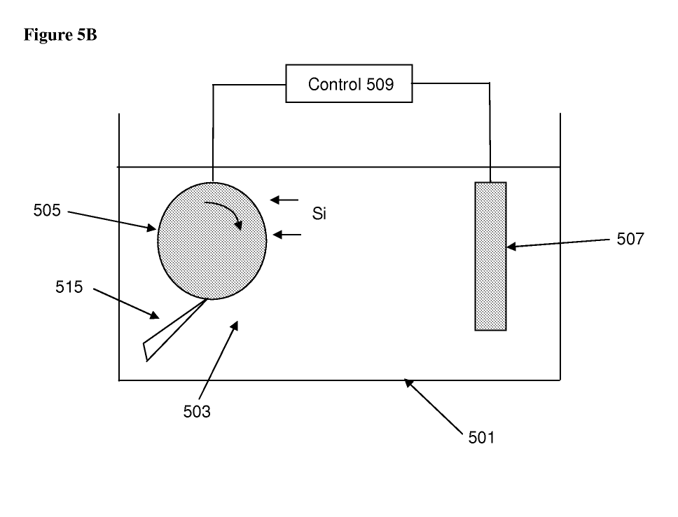

FIG. 5A illustrates an apparatus and process for forming active silicon anode material according to another embodiment of the invention. In this embodiment, a conductive foil provides the substrate 505 that moves between a supplying reel 511 and a receiving reel 513 in a reel-to-reel process. The substrate 505 may comprise one or more metal materials and/or an organic material. The organic material may conducting or non-conducting. The substrate 505 between the supplying and receiving reels is passed through an electrodeposition bath 503 comprising an electrolyte and a source of silicon dissolved therein, as described above with reference to FIG. 2. Supplying reel 511 may be a rotating cylinder electrode that is in electrical contact with the substrate and that is connected so as to form the working electrode of the electrodeposition apparatus. It will appreciated that receiving reel 513 could likewise be a rotating cylinder electrode. A counter electrode 507 is provided, as described above with reference to FIG. 2. A control unit 509 is connected to supplying reel 511 and counter electrode 507.

The rate at which the substrate moves between the two reels and the rate of electrodeposition may be selected according to the desired thickness of the electrodeposited film in addition to other factors of the deposition mechanism such as current density

A scraper 515 may be provided at the receiving reel to scrape the electrodeposited film off the substrate, for example to form silicon flakes suitable for formation of an anode, e.g. by deposition of a slurry as described in more detail below. Flakes formed by scraping the electrodeposited film may have dimensions as described with reference to FIG. 4.

The electrodeposited silicon material may alternatively be removed by etching or dissolving the surface layer of the substrate 505 on which the silicon material has been deposited. For example, substrate 505 may comprise a continuous or partial thin layer of silicon oxide or aluminium (or consist essentially of such material) on which the active silicon material is electrodeposited. After electrodeposition the aluminium or silicon oxide layer can be selectively etched away to free the active silicon material using techniques known to those skilled in the art that do not substantially etch the electrodeposited silicon. Alternatively the substrate 505 may comprise an organic material such as polyaniline, polypyrrole or other conductive polymers in a conductive form that is soluble in organic solvents. After electrodeposition of the silicon material onto the organic material, the organic material can be dissolved in an organic solvent to free the silicon material. The organic material can then be recast from solution and reused.

The substrate 505 or one component of it can be heated or chemically modified after the electrodeposition of the silicon material so that the substrate becomes brittle and by stretching, bending, scraping or mechanical agitation, the silicon material can be more easily removed from the substrate.

Equally, it will be recognised that there may be other substrate materials other than those listed herein that can be etched, dissolved or modified to become brittle in the ways described above.

Flakes or other particles of electrodeposited silicon removed from substrate 505 may be used without further size modification to form the anode of a lithium ion battery. Alternatively, the size of the removed particles may be reduced, as described above with reference to FIG. 4.

Once the supply of substrate from the supplying reel has been exhausted, the direction of rotation of the reels may be reversed with electrodeposition continuing with the reels operating in the reverse direction so that the receiving reel becomes the supplying reel and vice versa. Alternatively, the substrate may be rewound onto the supplying reel, or a new substrate may be wound onto the supplying reel, before electrodeposition recommences.

FIG. 5B illustrates an apparatus and process for forming active silicon anode material according to another embodiment of the invention. The apparatus is substantially as described with reference to FIG. 2, except that working electrode 505 is a rotating cylinder electrode. Silicon electrodeposited onto rotating cylinder electrode is scraped off a first region of the rotating cylinder electrode, whilst silicon is electrodeposited onto another region of the cylinder. The electrodeposited silicon may be scraped off in the form of flakes, as described with reference to FIG. 5A.

Rotating cylinder electrodes are described in more detail in, for example, J. Appl. Electrochem. 13 (1983) p. 3 and Hydrometallurgy 26 (1991) p. 93.

The surface of the substrate onto which electrodeposition takes place may be substantially smooth. Alternatively, the substrate may have a patterned surface.

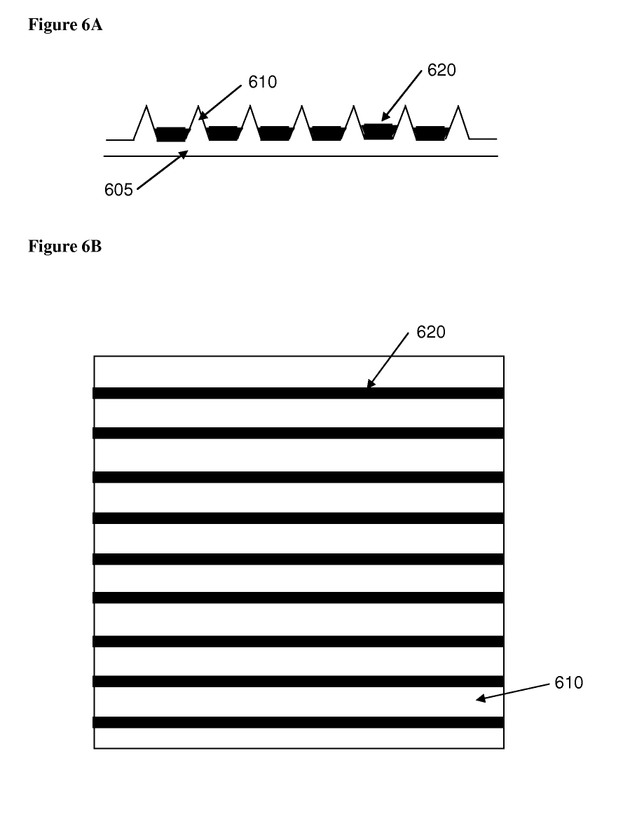

FIG. 6A illustrates schematically a cross-section of a conductive substrate 605 having a patterned surface. The patterned surface comprises raised areas 610 defining recesses into which the active material 620 may be electrodeposited.

The substrate may be provided in any form, for example a substrate forming a working electrode as described in FIGS. 2 and 5B above, or a substrate extending between a supplying reel or a receiving reel as described in FIG. 5A.

The rotating cylinder electrode 505 illustrated in FIG. 5B may be patterned, and silicon formed in the pattern defined by the patterned electrode may be removed during or after the electrodeposition process, either by scraping or other means.

FIG. 6B illustrates a plan view of the substrate 605 of FIG. 6A. In this embodiment, the recesses define channels, however it will be appreciated that the recesses may define any shape.

Silicon may be removed from the patterned substrate 605 and used to form an anode from a slurry as described in more detail below. In this case, the removed silicon may or may not be broken to form silicon particles of a smaller size, as described above with reference to FIG. 4, depending on the size of the silicon features formed by deposition onto the patterned substrate 605.

Alternatively, the patterned substrate 605 carrying the electrodeposited silicon 620 may be used directly to form a lithium ion battery, without removal of the electrodeposited silicon 620, in which case the substrate 605 becomes the anode current collector and the electrodeposited silicon 620 becomes the anode layer of the lithium ion battery.

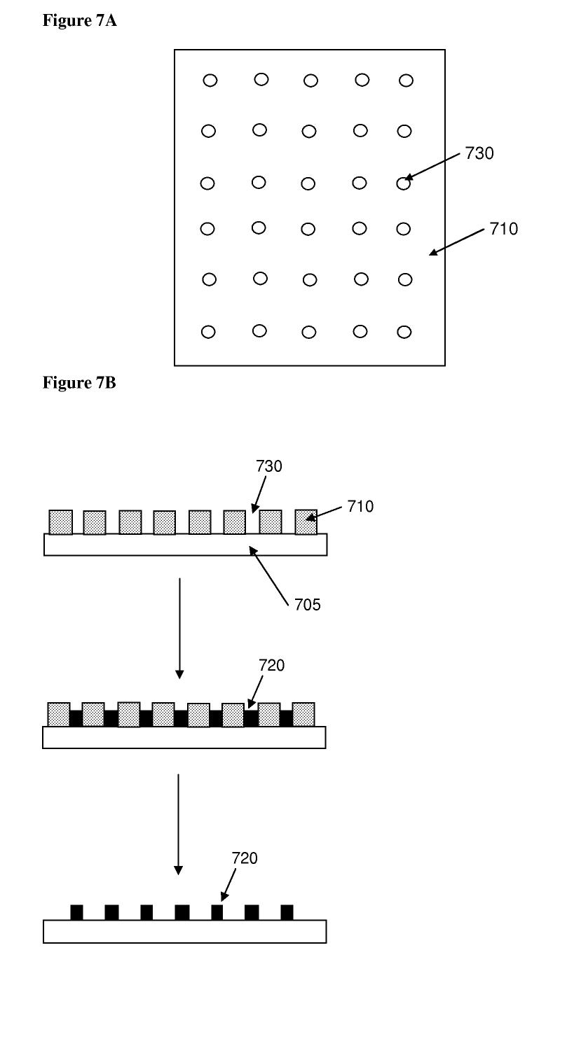

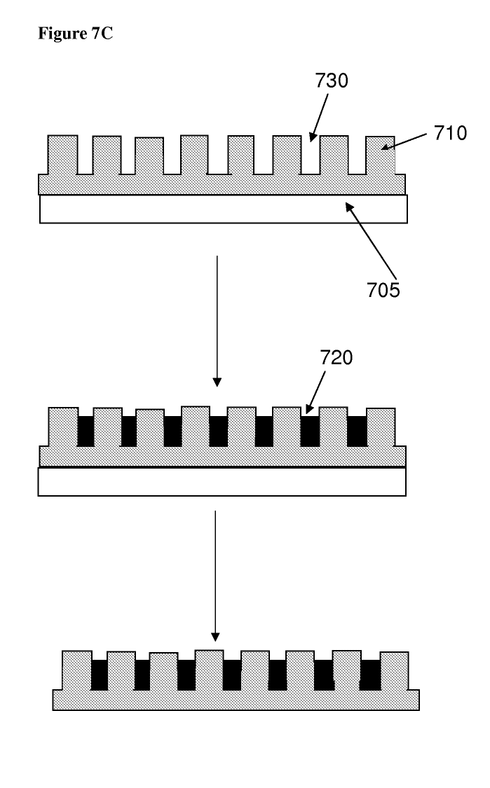

FIGS. 7A and 7B illustrate a method for formation of active silicon according to another embodiment.

A template 710 comprising apertures 730, for example a polycarbonate copper or nickel template, is provided over conductive substrate 705. The template may be formed from a conducting or non-conducting material. One method of forming a template is by liquid crystal templating to form a mesoporous film. During electrodeposition the electrolyte enters the apertures 730, such as the pores of a mesoporous film, and silicon is electrodeposited on the substrate 705 in the shape of the apertures.

When electrodeposition is complete the template is removed as illustrated in FIG. 7B, for example by dissolution of the template, to leave the substrate 705 carrying the patterned active material 720 extending from the substrate.

In another arrangement, a template release layer of a conducting or non-conducting material may be provided between the substrate 705 and the template to facilitate release of the template. If a conducting release layer is used then it will be appreciated that, in operation, the active material is electrodeposited onto the release layer and the working electrode is effectively provided by a combination of the conducting release layer together with substrate 705. A non-conducting template release layer may be patterned to provide apertures, for example in the same pattern as the template, such that the active material may deposit on the working electrode substrate 705.

Silicon 720 may be removed from the patterned substrate 705 and used to form an anode from a slurry as described in more detail below. In this case, the removed silicon may or may not be broken to form silicon particles of a smaller size, as described above with reference to FIG. 4 depending on the size of the silicon features formed on substrate 705. Optionally, the removed silicon is not reduced in size if its dimensions are within one or more of the particle size ranges described with reference to FIG. 4. By this method, particles of an active material may be formed during the electrodeposition process wherein the shape and/or dimensions of the electrodeposited particles are determined by the shape and/or dimensions of the template apertures, and wherein the shape and/or dimensions of the particles may be adjusted by post-electrodeposition of the particles.

Alternatively, the substrate 705 carrying the electrodeposited silicon 720 may be used directly to form a lithium ion battery, without removal of the electrodeposited silicon 720, in which case the substrate 705 becomes the anode current collector and the electrodeposited silicon 720 becomes the anode layer of the lithium ion battery.

FIG. 7C illustrates an electrodeposition process using another template 710 comprising apertures 730 that extend along some but not all of the thickness of the template. In this case, the template is formed from a conducting material and electrodepo sited material 720 forms on a base of the template in apertures 730. Active material may also be deposited on the upper surface of template 710. In this embodiment, electrically connected substrate 705 and template 710 together effectively form the working electrode during electrodeposition. Following electrodeposition, the template 720 may be separated from substrate 705.

Accordingly, it will be appreciated that use of a template that may be separated from the substrate it is applied to includes: use of a non-conducting template that does not form part of the working electrode during electrodeposition; use of a conducting template that, along with the conducting substrate it is applied to, effectively does form part of the working electrode during electrodeposition in which case the conducting template may provide an electrodeposition surface of the working electrode; use of a non-conducting release layer that does not form part of the working electrode during electrodeposition; and use of a conducting release layer that, along with the conducting substrate it is applied to, does effectively form part of the working electrode during electrodeposition in which case the conducting release layer may provide an electrodeposition surface of the working electrode.

The surface of any of the working electrodes described above may be provided with non-conductive (that is highly resistive or insulating) features, such as non-conductive lines or non-conductive islands, and electrodeposition may preferentially take place on areas of the conductive working electrode surface between these non-conductive features.

FIG. 8 illustrates an apparatus and a process for forming active silicon anode material according to another embodiment of the invention. FIG. 8 is an example of electrodeposition onto conductive particles provided in the form of a fluidised bed wherein the particles are constrained to one part of the electrodeposition apparatus near the working electrode of the apparatus. Agitation of the particles, for example by stirring or tumbling the particles, may take place during electrodeposition in order to change the surface of the fluidised bed at which electrodeposition takes place. In another arrangement, some or all of the particles may be essentially immobile. For example, the particles may be provided as a packed bed.

In the embodiment of FIG. 8, silicon is electrodeposited onto solid, hollow or porous core particles 810 by electrodeposition in a fluidised bed coater 800. The fluidised bed coater 800 includes a working electrode current collector 805, a counter electrode 807, conductive particles 810 in electrical contact with working electrode current collector 805 and a porous membrane or separator 817. The working electrode current collector 805 and counter electrode 807 are connected to a control, and a reference electrode may be provided.

Electrolyte 803 flows through the fluidised bed coater between electrolyte inlets 819 and electrolyte outlets 821. FIG. 8 illustrates an inlet 819 and an outlet 821 on either side of porous membrane or separator 817, although it will be appreciated that a larger number of inlets 819 and outlets 821 may be provided, or only one inlet 819 and one outlet 821 may be provided. Inlet 819 and outlet 821 may have a fine mesh allowing passage of electrolyte but not particles 810 out of the coater 800. The same electrolyte or different electrolytes may be used in the two compartments of the coater 800.

Working electrode current collector 805 is typically porous, and may for example be a mesh electrode, allowing electrolyte 803 to flow through the working electrode current collector 805. Counter electrode 807 may take any suitable form, including mesh and solid plate forms. The electrolyte may be, for example, an electrolyte as described with reference to FIG. 2 containing a dissolved source of silicon. The particles 810 may be agitated, for example by one or more of movement of the electrolyte, stifling the particles 810 and providing the particles 810 in a rotating vessel, such that substantially all surfaces of substantially all of the core particles are coated.

In operation, silicon is electrodeposited onto conductive particles 810 to form particles of a silicon coating on a core of the conductive particles 810. The electrodeposited coating on the particles may have thickness of up to 10 μm, for example no more than 5 microns, optionally less than 0.5 microns. The particles 810 illustrated in FIG. 8 are substantially spherical, however the particles 810 may have other shapes.

Particles onto which silicon is electrodeposited to form a core particle with an electrodeposited coating, for example by a process as described with reference to FIG. 8, may be in the form of flakes or wires, or cuboid, substantially spherical or spheroid particles. Non-spherical core particles may have an aspect ratio of at least 1.5:1, optionally at least 2:1. The core particles may be of any material suitable for use in a metal-ion cell but preferably they are formed from a conducting material. Exemplary conducting core particles may include metals and conductive forms of carbon, for example conductive nanotubes, conductive nanofibres, graphite, graphene, crystalline silicon or tin, doped silicon or alloys, oxides, nitrides, hydrides, fluorides, mixtures, compounds or agglomerates of such materials.

The particles may have a size with a largest dimension up to about 100 μm, preferably less than 50 μm, more preferably less than 30 μm, for example carbon spheres having a 5 micron diameter.

The coated particles may have at least one smallest dimension less than one micron. Preferably the smallest dimension is less than 500 nm, more preferably less than 300 nm. The smallest dimension may be more than 0.5 nm. The smallest dimension of a particle is defined as the size of the smallest dimension of an element of the particle such as the diameter for a rod, fibre or wire, the smallest diameter of a cuboid or spheroid or the smallest average thickness for a ribbon, flake or sheet where the particle may consist of the rod, fibre, wire, cuboid, spheroid, ribbon, flake or sheet itself or may comprise the rod, fibre, wire, cuboid, spheroid, ribbon, flake or sheet as a structural element of the particle.

Preferably the particle has a largest dimension that is no more than 100 μm, more preferably, no more than 50 μm and especially no more than 30 μm.

Particle sizes may be measured using microscopy techniques and methods, for example scanning electron microscopy or transmission electron microscopy.

In a composition containing a plurality of particles, for example a powder, preferably at least 20%, more preferably at least 50% of the particles have smallest and/or largest dimensions in the ranges defined herein. Particle size distribution may be measured using laser diffraction methods or optical digital imaging methods.

A distribution of particle sizes, including particles consisting essentially of doped or undoped silicon and particles having an electrodeposited coating of silicon, may optionally be measured by a laser diffraction method in which the particles being measured are typically assumed to be spherical and in which particle size is expressed as a spherical equivalent volume diameter, for example using the Mastersizer™ particle size analyzer available from Malvern Instruments Ltd. A spherical equivalent volume diameter is the diameter of a sphere with the same volume as that of the particle being measured. For measurement the powder is typically dispersed in a medium with a refractive index that is different to the refractive index of the powder material. A suitable dispersant for powders of the present invention is water. For a powder with different size dimensions such a particle size analyser provides a spherical equivalent volume diameter distribution curve.

Size distribution of particles in a powder measured in this way may be expressed as a diameter value Dn in which at least n % of the volume of the powder is formed from particles have a measured spherical equivalent volume diameter equal to or less than D.

Optionally, a powder of active particles has D₉₀≦60 microns, optionally≦30 microns, optionally≦25 microns.

Optionally, a powder of active particles has D₅₀≦20 microns, optionally≦15 microns, optionally≦12 microns.

Optionally, a powder of active particles has D₁₀≧100 nm, optionally≧500 nm, optionally≧1000 nm.

Optionally, (D₉₀−D₅₀)/D₁₀ is less than 1.

The coated particle may or may not undergo modification before being used as the active material of a lithium ion battery anode. One preferred modification is etching of the coated particle, with an optional crystallization treatment pre-etch, to form a pillared particle or a porous shell particle, although it will be appreciated that particles coated with amorphous active material may also be etched. Other preferred modifications include passivation, doping and/or incorporation of active metal-ions.

The coated particles may be maintained in an inert environment, in particular an oxygen and/or moisture—free environment, following electrodeposition and before etching. Alternatively or additionally, a passivating layer as described anywhere herein may be applied to the surface of the electrodeposited material prior to etching.

In another arrangement, the coating of electrodeposited material could be separated from the particle core, leaving partial shells of Si with characteristic thickness of 0.5 nm to 1 micron for use as an active material of a metal ion battery. The coating may be removed from the particle core by any method, including mechanical and chemical methods. In the case of a carbon particle core, the core could be partially or completely removed by oxidation of the core to form carbon dioxide. Methods for removing flakes of the electrodeposited material from the particle core include crushing and etching.

FIG. 9 illustrates a first step in which a conductive particle 910, such as graphite or a metal, is provided with a coating of silicon 920 by electrodeposition, for example by electrodeposition in a fluidised bed arrangement as described in FIG. 8. The silicon coating may then be fully or partially crystallized, for example by annealing, to convert the coating 920 from amorphous to crystalline silicon prior to etching, although it will be understood that amorphous silicon may also be etched. The coating 920 is etched to form a pillared particle comprising a core of the conductive particle 910 with silicon coating 920′ that is thinner than the thickness of coating 920 before etching, and silicon pillars 930 integral with and extending from the remaining coating 920′. Alternatively the coated particle may be etched to provide a porous silicon coating or shell.

If particles are to be etched following electrodeposition onto a particle then the thickness of the electrodeposited film may be formed to a thickness of about 2-10 microns, and etching of the electrodeposited coating may be to a depth of less than 2-5 microns, optionally at least 0.5 microns. For example, a 2.5 micron coating may be etched to a depth of 2 microns to leave a coating 920′ of 0.5 microns carrying pillars 930 having a length of 2 microns.

The pillars may have any shape. For example, the pillars may be branched or unbranched; substantially straight or bent; and of a substantially constant thickness or tapering.

The pillars are spaced apart on surface 920′. In one arrangement, substantially all pillars may be spaced apart. In another arrangement, some of the pillars 930 may be clustered together.

A suitable etching process comprises treatment of the coated particle with hydrogen fluoride, a source of silver ions and a source of nitrate ions.

The etching process may comprise two steps, including a nucleation step in which silver nanoclusters are formed on the silicon surface of the coated particle and an etching step. The presence of an ion that may be reduced is required for the etching step. Exemplary cations suitable for this purpose include nitrates of silver, iron (III), alkali metals and ammonium. The formation of pillars may either be as a result of etching taking place at areas of the silicon surface that remain exposed following formation of the nanoclusters to leave pillars in the areas underlying the silver nanoclusters, or as a result of etching selectively taking place in the areas underlying the silver nanoclusters.

The nucleation and etching steps may take place in a single solution or may take place in two separate solutions.

Silver may be recovered from the reaction mixture for re-use.

Etching of silicon with HF results in formation of H₂SiF₆. Silica may be generated from this by-product of the etching process according to the following reaction:

H₂SiF₆+2H₂O→6HF+SiO₂(s)

The silica product of this reaction may be used to generate a silicon tetrahalide, as described above. The yield of active material from starting material when this recycling step is used has a theoretical maximum of 100%. In contrast, etching of granules of silicon formed from silicon sources such as semiconductor wafers or metallurgical grade silicon may be more expensive in view of the cost of the starting material, and may be lower yielding due to disposal of H₂SiF₆ formed in the etching process.

Exemplary etching processes suitable for forming porous or pillared particles are disclosed in WO 2009/010758 and in WO 2010/040985, and include stain etching as disclosed in, for example, U.S. Pat. No. 7,244,513.

Particles formed from a film of electrodeposited material, for example as described with reference to FIG. 4, may be etched to form pillared particles in the same way as etching of coated particles as described above.

### Battery Formation

A slurry comprising the active material and one or more solvents may be deposited over an anode current collector to form an anode layer. The slurry may further comprise a binder material, for example polyimide, polyacrylic acid (PAA) and alkali metal salts thereof, polyvinylalchol (PVA) and polyvinylidene fluoride (PVDF), sodium carboxymethylcellulose (Na-CMC) and optionally, non-active conductive additives, for example carbon black, carbon fibres, ketjen black or carbon nanotubes. One or more further active materials, for example an active form of carbon such as graphite or graphene, may also be provided in the slurry. Active graphite may provide for a larger number of charge/discharge cycles without significant loss of capacity than active silicon, whereas silicon may provide for a higher capacity than graphite. Accordingly, an electrode composition comprising a silicon-containing active material and a graphite active material may provide a lithium ion battery with the advantages of both high capacity and a large number of charge/discharge cycles. The slurry may be deposited on a current collector of metal foil, for example copper, nickel or aluminium, or a non-metallic current collector such as carbon paper, and dried so that the solvent evaporates to form a composite electrode layer on the current collector. Further treatments may be done as required, for example to directly bond the silicon particles to each other and/or to the current collector. Binder material or other coatings may also be applied to the surface of the composite electrode layer after initial formation.

Another method of forming an anode layer is by thermally bonding particles comprising the electrodeposited active material onto an anode current collector such as a metal layer as described above. Particles having silicon at a surface thereof, for example silicon fibres, may be thermally bonded to an anode current collector layer. A thermally bonded anode layer may consist essentially of the thermally bonded particles comprising the electrodeposited active material, or the layer may contain one or more further components. Exemplary further components may be as described above and include, without limitation, a binder, one or more further active materials and one or more conductive additives.

The resulting composite electrode layer may preferably comprise elements in the following amounts:

Active material of 50-90% by mass wherein at least 5% by mass of the active material is silicon, optionally at least 10% by mass;

Binder material of 0-50% by mass, optionally 5-20% by mass;

Non-active conductive additives of 0-50% by mass, optionally 5-30% by mass;

Other additives and/or coatings of 0-25% by mass;

whereby the sum of the percentages equals 100%. The mass percentages of the composite electrode layer are the percentages of a dry composition, not a composition in which one or more solvents is present.

Other additive materials that may be provided in the slurry include, without limitation, a viscosity adjuster, a filler, a cross-linking accelerator, bonding agents, ionic conductors, a coupling agent and an adhesive accelerator.

The composite electrode layer preferably has a porosity of at least 5%, more preferably at least 15% and may be at least 30%. This allows space for expansion of the active material during charging and promotes contact of the electrolyte with the active material. However if the porosity is too high the structural integrity may suffer and the overall capacity of the electrode is reduced. Preferably it is less than 75%.

Examples of suitable cathode materials include LiCoO₂, LiMnₓNiₓCo₁₋₂ₓO₂, LiFePO₄, LiCo_{0.99}Al_{0.01}O₂, LiNiO₂, LiMnO₂, LiCo_{0.5}Ni_{0.5}O₂, LiCo_{0.7}Ni_{0.3}O₂, LiCO_{0.8}Ni_{0.2}O₂, LiCO_{0.82}Ni_{0.18}O₂, LiCo_{0.8}Ni_{0.15}Al_{0.05}O₂, LiNi_{0.4}Co_{0.3}Mn_{0.3}O₂ and LiNi_{0.33}Co_{0.33}Mn_{0.34}O₂. The cathode current collector is generally of a thickness of between 3 to 500 μm. Examples of materials that can be used as the cathode current collector include aluminium, stainless steel, nickel, titanium and sintered carbon.

The electrolyte is suitably a non-aqueous electrolyte containing a lithium salt and may include, without limitation, non-aqueous electrolytic solutions, solid electrolytes and inorganic solid electrolytes. Examples of non-aqueous electrolyte solutions that can be used include non-protic organic solvents such as propylene carbonate, ethylene carbonate, butylenes carbonate, dimethyl carbonate, diethyl carbonate, gamma butyro lactone, 1,2-dimethoxy ethane, 2-methyl tetrahydrofuran, dimethylsulphoxide, 1,3-dioxolane, formamide, dimethylformamide, acetonitrile, nitromethane, methylformate, methyl acetate, phosphoric acid trimester, trimethoxy methane, sulpholane, methyl sulpholane and 1,3-dimethyl-2-imidazolidione.

Examples of organic solid electrolytes include polyethylene derivatives polyethyleneoxide derivatives, polypropylene oxide derivatives, phosphoric acid ester polymers, polyester sulphide, polyvinyl alcohols, polyvinylidine fluoride and polymers containing ionic dissociation groups.

Examples of inorganic solid electrolytes include nitrides, halides and sulphides of lithium salts such as Li₅NI₂, Li₃N, Lii, LiSiO₄, Li₂SiS₃, Li₄SiO₄, LiOH and Li₃PO₄.

The lithium salt is suitably soluble in the chosen solvent or mixture of solvents. Examples of suitable lithium salts include LiCl, LiBr, LiI, LiClO₄, LiBF₄, LiBC₄O₈, LiPF₆, LiCF₃SO₃, LiAsF₆, LiSbF₆, LiAlCl₄, CH₃SO₃L₁ and CF₃SO₃Li.

Where the electrolyte is a non-aqueous organic solution, the battery is provided with a separator interposed between the anode and the cathode. The separator is typically formed of an insulating material having high ion permeability and high mechanical strength. The separator typically has a pore diameter of between 0.01 and 100 μm and a thickness of between 5 and 300 μm. Examples of suitable electrode separators include a micro-porous polyethylene film.

Although the present invention has been described in terms of specific exemplary embodiments, it will be appreciated that various modifications, alterations and/or combinations of features disclosed herein will be apparent to those skilled in the art without departing from the scope of the invention as set forth in the following claims.

1. A method of forming a plurality of particles comprising an active material suitable for use in a metal ion battery, the method comprising the steps of:
providing a working electrode in an electrodeposition bath wherein the electrodeposition bath contains an electrolyte comprising a source of the active material;
electrodepositing the active material onto a surface of the working electrode, onto a surface of a conducting layer in electrical contact with the working electrode, or onto a surface of conductive particles in the electrolyte; and
providing the particles comprising the active material, wherein the step of providing the particles comprises separation of the electrodeposited material from the working electrode or separation of the conductive particles carrying the electrodeposited active material from the working electrode.

2. A method according to claim 1 wherein the active material is electrodeposited into pores of a porous template over the working electrode.

3. A method according to claim 2 wherein the template is in contact with the working electrode or wherein a template release layer is provided between the working electrode and the template.

4. A method according to claim 3 wherein the active material is electrodeposited onto a surface of the template or a surface of the template release layer.

5. A method according to claim any preceding claim wherein the working electrode is a rotating cylinder electrode.

6. A method according to claim 5 wherein the working electrode extends between and is movable between a substrate source and a substrate receiver, and a path between the substrate source and the substrate receiver passes through the electrodeposition bath.

7. A method according to claim 6 wherein the substrate source is a substrate-supplying reel and the substrate receiver is a substrate-receiving reel.

8. A method according to claim 6 or 7 wherein the working electrode is drawn through the electrodeposition bath and different parts of the working electrode surface undergo electrodeposition at different times.

9. A method according to claim 7 or 8 wherein the substrate-supplying reel or substrate-receiving reel is a rotating cylinder electrode in electrical contact with the working electrode.

10. A method according to any of claims 1-9 wherein the surface of the working electrode is patterned to define recesses on the surface for formation of patterned active material by electrodeposition.

11. A method according to claim 9 wherein the electroactive material is formed on a surface of the working electrode and is separated from the working electrode by selective etching or dissolving of the working electrode.

12. A method according to claim 10 or 11 wherein the working electrode is treated to increase its brittleness prior to separation of the working electrode from the active material.

13. A method according to any preceding claim wherein the step of providing the particles comprises treating the electrodeposited active material deposited onto the working electrode to form the particles.

14. A method according to claim 13 wherein the electrodeposited material is separated from the working electrode and wherein the separated electroactive material is treated to form the particles having a mean average size smaller than the size of the removed material prior to said treatment.

15. A method according to any preceding claim comprising the step of etching the surface of the particles.

16. A method according to claim 15 wherein the particles are etched to form pillared particles comprising a particle core and pillars extending from the particle core.

17. A method according to claim 1 wherein the active material is electrodeposited onto the surface of conductive particles in the electrolyte and wherein the deposited active material at least partially coats the conductive particles.

18. A method according to claim 17 wherein the plurality of conductive particles form a packed bed during the electrodeposition.

19. A method according to claim 17 wherein the plurality of conductive particles form a fluidised bed during the electrodeposition.

20. A method according to any of claims claims 17-19 comprising a step of removing at least part of the coating of the active material by etching.

21. A method according to any of claims 17-20 wherein the coating of the active material is etched to form pillars on the surface of the particles.

22. A method according to any of claim 15, 16, 20 or 21 wherein the electrodeposited active material is silicon and the etchant is hydrogen fluoride, the method comprising the further step of generating silica from H₂SiF₆ formed in the etching process.

23. A method according to any of claims 1-22 wherein the active material is selected from silicon, tin and aluminium.

24. A method according to claim 23 wherein the active material is silicon and the source of the active material is a silicon tetrahalide.

25. A method according to claim 24 wherein elemental halogen is generated from the silicon tetrahalide during electrodeposition and wherein the elemental halogen is reacted with a silicon oxide to generate further silicon tetrahalide.

26. A method according to any preceding claim wherein the particles comprising the active material are particles active material have at least one dimension in the range of 0.5 nm-1 micron.

27. A method according to any preceding claim comprising the step of mixing the particles comprising the active material with a solvent to form a slurry.

28. A method according to claim 27 comprising the step of mixing the particles comprising the active material with at least one other material.

29. A method according to claim 28 wherein the at least one other material is an active material and/or a conductive material.

30. A method according to any preceding claim wherein a gas is bubbled through the electrolyte during the electrodeposition.

31. A method according to any preceding claim wherein the electrodeposited active material is amorphous and wherein the amorphous active material is rendered at least partially crystalline by a heat treatment.

32. A method according to any preceding claim wherein a passivating film is formed on the electrodeposited active material.

33. A method of forming an electrode layer, the method comprising the step of depositing the particles comprising the active material according to any preceding claim onto a conductive material.

34. A method according to claim 33 wherein the particles comprising the active material are thermally bonded to the conductive material.

35. A method of forming an electrode layer according to claim 33 comprising the step of depositing the slurry according to any of claims 27-29 onto the conductive material and evaporating the solvent.

36. A method according to any of claims 33-35 wherein the electrode layer is an anode layer of a metal ion battery.

37. A method of forming a metal ion battery comprising formation of a structure comprising an electrolyte between the anode according to claim 36 and a cathode capable of releasing and absorbing the metal ion.

38. A method of forming particles comprising an active material suitable for a metal ion battery, the method comprising the steps of:
providing a working electrode in an electrodeposition bath wherein the electrodeposition bath contains an electrolyte comprising a source of the active material; and
electrodepositing the active material onto a surface of the working electrode; and
separating the electrodeposited active material from the working electrode; and
treating the active material separated from the working electrode to form particles having a mean average size smaller than the size of the removed material prior to said treatment.

39. A method of forming particles comprising an active material suitable for a metal ion battery, the method comprising the steps of:
providing a working electrode in an electrodeposition bath wherein the electrodeposition bath contains an electrolyte comprising a source of the active material; and
electrodepositing the active material into pores of a porous template in contact with the working electrode.

40. A method of forming particles comprising an active material suitable for a metal ion battery, the method comprising the steps of:
providing conductive particles in an electrolyte of an electrodeposition bath wherein the electrolyte comprises a source of the active material; and
electrodepositing the active material onto the conductive particles to at least partially coat the conductive particles.

41. A method of forming an electrode layer, the method comprising the step of depositing the particles comprising the active material according to any of claims 38-40 onto a conductive material.

42. A method according to claim 41 wherein the particles comprising the active material are thermally bonded to the conductive material.

43. A method according to claim 41 comprising the step of depositing a slurry comprising the particles comprising the active material and a solvent onto the conductive material and evaporating the solvent.

44. A method according to any of claims 41-43 wherein the electrode layer is an anode layer of a metal ion battery.

45. A method of forming a metal ion battery comprising formation of a structure comprising an electrolyte between the anode according to claim 44 and a cathode capable of releasing and absorbing the metal ion.

46. A method of recycling elemental halogen comprising the steps of:
generating elemental halogen by electrolytic reduction of a silicon halide during electrodeposition of silicon; and
reacting the generated elemental halogen with a silicon oxide to generate further silicon halide.

47. A method according to claim 46 wherein the silicon halide is a silicon trihalide or tetrahalide, and wherein the halide is optionally a bromide or chloride.
